(19) United States
(12) Patent Application Publication
(10) Pub. No.: US 2007/0049703 A1
(43) Pub. Date: Mar. 1, 2007

(54) STATIC DISSIPATING RESIN COMPOSITIONS, METHODS FOR MANUFACTURE AND ARTICLES MADE THEREFROM

(76) Inventors: Michael C. Murray, Ontario (CA); Lawrence D. Lucco, Parkesburg, PA (US); James J. Fagan, Hoeny Brook, PA (US)

Correspondence Address: GEAM - LNP-CE 08CE;IP LEGAL, ONE PLASTICS AVENUE, PITTSFIELD, MA, 01201-3697, US

(21) Appl. No.: 11/551,791

(22) Filed: Oct. 23, 2006

Related U.S. Application Data
(63) Continuation-in-part of application No. 11/356,252, filed on Feb. 16, 2006.
Application No. 11/356,252 is a continuation of application No. 10/691,686, filed on Oct. 23, 2003, now Pat. No. 7,022,764.
(60) Provisional application No. 60/434,855, filed on Dec. 18, 2002.

(51) Int. Cl. C08L 67/00; C08L 69/00; G02B 5/02

(52) U.S. Cl. 525/439; 252/582

(57) ABSTRACT

A substantially transparent antistatic, impact resistant, molding composition and articles made from this composition. The composition includes a miscible mixture of a polycarbonate resin and a cycloaliphatic polyester resin, and an antistatic polymeric material wherein the mixture of the polycarbonate and the cycloaliphatic polyester resin is present in suitable proportions for substantially matching the index of refraction of the antistatic polymeric material, thereby enabling the composition, and any articles made from the composition, to be substantially transparent. The composition may be used in a variety of articles in the electrical and electronic equipment, electronic packaging, and healthcare fields, as well as others.

### CROSS REFERENCE TO RELATED APPLICATIONS

This application is a continuation-in-part application of U.S. patent application Ser. No. 11/356,252, filed Feb. 16, 2006, which was a continuation of U.S. patent application Ser. No. 10/691,686, filed Oct. 23, 2003, now allowed, which claimed priority to U.S. Provisional Application Ser. No. 60/434,855 filed on Dec. 18, 2002.

### FIELD OF INVENTION

This invention relates to thermoplastic permanent electrostatic dissipating compositions having substantial transparency and articles that include one or more of these compositions.

### BACKGROUND OF INVENTION

Polymeric resins are suitable for a large number of applications because of their high strength-to-weight ratio and ease of processing. Polymeric resins, however, are insulating in nature and are therefore electrostatic charges can build on plastic when subjected to frictional forces such as rubbing. Their inability to dissipate such electrostatic charges leads them to attract dust and foreign particles, thereby spoiling the appearance of molded parts made there from. Additionally, the build up of electrostatic charges renders the polymeric resin unusable in certain electrical and electronic applications.

Polymeric resins and articles having antistatic properties are typically obtained by directly blending antistatic agents with the polymeric resins during a compounding process. Unfortunately, the antistatic agent often migrates to the surface layer of the article over time, lowering the antistatic properties due to frictional wear of the surface layer. A need therefore remains for stable antistatic compositions wherein the antistatic agent remains well dispersed in the bulk of the polymeric resin during high temperature processing and subsequent use.

Therefore, it would be beneficial to have polymeric resins that possess antistatic properties (i.e., are electrostatically conductive) and that maintain these properties at the elevated temperatures used in processing these materials. It would also be beneficial to have articles that exhibited these characteristics. In addition it would be beneficial to have antistatic compositions and articles that were transparent for use in electronic packaging where it is important to be able to see the part when packaged.

### SUMMARY OF INVENTION

The present invention relates to permanent electrostatic dissipating compositions having excellent transparency and impact resistances and articles made from these compositions. Antistatic compositions including polymeric resins and a static dissipating resin are often opaque which is undesirable, especially in electronic packaging applications. In particular it is very difficult to add a static dissipating polymer to polycarbonate resins to achieve a transparent product. Nevertheless, the compositions of the present invention, and articles made that include one or more of these compositions, provide a product that helps dissipate static and help solve one or more problems associated with prior art materials.

Accordingly, in one aspect, the present invention provides a substantially transparent antistatic, impact resistant, molding composition that includes a major portion by weight percent of a miscible mixture of a polycarbonate resin and a polyester resin, and an antistatic polymeric material wherein the mixture of the polycarbonate and the polyester resin is present in suitable proportions for substantially matching the index of refraction of the antistatic polymeric material.

According to another embodiment, the composition includes additional miscible resins provided the additional miscible resins together with the polycarbonate and polyester resins form a mixture that substantially matches the index of refraction of the antistatic polymeric material.

According to another embodiment, additional ingredients in the form of immiscible resins present in the molding composition beneficially have an index of refraction substantially matching the index of refraction of the antistatic polymeric material.

In still another embodiment, the present invention provides articles that are made from the compositions of the present invention, and especially include articles that are substantially transparent.

Owing to its excellent antistatic, impact and transparent properties, the compositions may be utilized in electrical and electronic equipment, electronic packaging and other applications requiring antistatic or anti-dust properties.

Accordingly, in one aspect, the present invention provides an article of manufacture including a transparent permanent electrostatic dissipating composition comprising a miscible mixture of an aromatic polycarbonate resin and a polyester resin, and an amount of an electrostatic dissipating polymer sufficient to impart electrostatic dissipative properties to the article; wherein the aromatic polycarbonate, the polyester, and the electrostatic dissipating polymer, each have a predetermined index of refraction. In addition, the electrostatic dissipating polymer has a refractive index value between the refractive index value of the polycarbonate resin and the refractive index value of the polyester resin. Also, the miscible mixture of the polycarbonate resin and the polyester resin are present in the electrostatic dissipating composition for substantially matching the index of refraction of the electrostatic dissipating polymer and wherein the refractive index of the miscible mixture is within 0.015 units of the refractive index of the electrostatic dissipating polymer.

### DETAILED DESCRIPTION OF PREFERRED EMBODIMENTS

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides substantially transparent antistatic, impact resistant, molding compositions and articles made from these compositions. The composition includes, in one embodiment, a miscible mixture of a polycarbonate resin and a polyester resin, and an antistatic polymeric material. The mixture of the polycarbonate and the polyester resin is present in proportions that enable the index of refraction of the antistatic polymeric material to be substantially matched, thereby enabling the composition, and any articles made from the composition, to be substantially transparent.

According to one embodiment of the present invention, the addition of a polyester resin (such as poly(cyclohexane-1,4-dimethylene cylohexane-1,4 dicarboxylate) hereinafter PCCD) of various viscosities of about MV2000 to about 6000 poise in combination with a polymeric static dissipative material having an index of refraction of about 1.52 to about 1.44 (RI), such as, in one embodiment, a polyetheresteramide, and an aromatic polycarbonate resin having a weight average molecular weight of from 22000 to 30000 produces substantially clear, antistatic compositions with high impact properties. The polyester resin has, in one embodiment, an index of refraction less than the index of refraction of the polymeric antistatic material and the polycarbonate beneficially has, in one embodiment, an index of refraction greater than the index of refraction of the antistatic material. The proportions of polyester resin and polycarbonate resin are selected so that the resulting index of refraction of the miscible mixture substantially matches the index of refraction of the antistatic polymeric material. In one embodiment, the refractive index of the miscible mixture is within 0.015 units of the polymeric antistatic material utilized. In another embodiment, the refractive index of the miscible mixture is within 0.005 units of the polymeric antistatic material utilized. In still another embodiment, the refractive index of the miscible mixture is within 0.003 units of the polymeric antistatic material utilized.

The term aromatic polycarbonate resin, includes aromatic carbonate chain units and includes compositions having structural units of the formula (I): 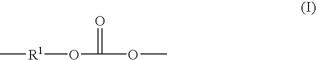
in which at least about 60 percent of the total number of R¹ groups are aromatic organic radicals and the balance thereof are aliphatic, alicyclic, or aromatic radicals. In one embodiment, R¹ is an aromatic organic radical and, in another embodiment, an aromatic organic radical of the formula (II):
-A¹-Y¹-A² (II)
wherein each of A¹ and A² is a monocyclic, divalent aryl radical and Y¹ is a bridging radical having one or two atoms which separate A¹ from A². In an exemplary embodiment, one such atom separates A¹ from A². Illustrative non-limiting examples of Y¹ are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene or isopropylidene.

Polycarbonate resins can be produced by the reaction of the carbonate precursor with dihydroxy compounds. As used herein, the term “dihydroxy compound” includes, for example, bisphenol compounds having general formula (III) as follows: 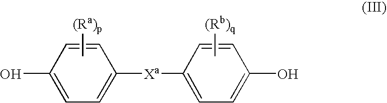
wherein R^{a} and R^{b} each represent a halogen atom, for example chlorine or bromine, or a monovalent hydrocarbon group, preferably having from 1 to 10 carbon atoms, and may be the same or different; p and q are each independently integers from 0 to 4; In one embodiment, X^{a} represents one of the groups of formula (IV): 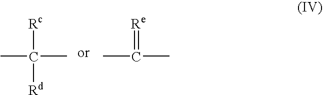
wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the dihydroxy-substituted aromatic hydrocarbons disclosed in U.S. Pat. No. 4,217,438. A nonexclusive list of specific examples of the types of bisphenol compounds that may be represented by formula (III) includes 1,1-bis(4-hydroxyphenyl) methane; 1,1-bis(4-hydroxyphenyl) ethane; 2,2-bis(4-hydroxyphenyl) propane (hereinafter “bisphenol A” or “BPA”); 2,2-bis(4-hydroxyphenyl) butane; 2,2-bis(4-hydroxyphenyl) octane; 1,1-bis(4-hydroxyphenyl) propane; 1,1-bis(4-hydroxyphenyl) n-butane; bis(4-hydroxyphenyl) phenylmethane; 2,2-bis(4-hydroxy-1-methylphenyl) propane; 1,1-bis(4-hydroxy-t-butylphenyl) propane; bis(hydroxyaryl) alkanes such as 2,2-bis(4-hydroxy-3-bromophenyl) propane; 1,1-bis(4-hydroxyphenyl) cyclopentane; and bis(hydroxyaryl) cycloalkanes such as 1,1-bis(4-hydroxyphenyl) cyclohexane. In an alternative embodiment, two or more different dihydric phenols are used.

Typical carbonate precursors include the carbonyl halides, for example carbonyl chloride (phosgene), and carbonyl bromide; the bis-haloformates, for example the bis-haloformates of dihydric phenols such as bisphenol A, hydroquinone, and the like, and the bis-haloformates of glycols such as ethylene glycol and neopentyl glycol; and the diaryl carbonates, such as diphenyl carbonate, di(tolyl) carbonate, and di(naphthyl) carbonate.

The term “antistatic electrostatic dissipating polymer” (hereinafter antistatic polymer) refers to one or more materials that can be either melt-processed into polymeric resins or sprayed onto commercially available polymeric forms and shapes to improve conductive properties and overall physical performance. Typical, monomeric antistatic agents are glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, quaternary ammonium salts, quaternary ammonium resins, imidazoline derivatives, sorbitan esters, ethanolamides, betaines and mixtures of the foregoing.

Typical polymeric antistatic polymers include, but are not limited to: copolyesteramides, polyether-polyamides, polyetheramide block copolymers, polyetheresteramide block copolymers, polyurethanes containing a polyalkylene glycol moiety, polyetheresters and mixtures thereof. Polymeric antistatic materials are useful since they are typically fairly thermally stable and processable in the melt state in their neat form or in blends with other polymeric resins. The polyetheramides, polyetheresters and polyetheresteramides include block copolymers and graft copolymers both of which are obtained by the reaction between a polyamide-forming compound and/or a polyester-forming compound, and a compound containing a polyalkylene oxide unit. Polyamide forming compounds include aminocarboxylic acids such as ω-aminocaproic acid, ω-aminoenanthic acid, ω-aminocaprylic acid, ω-aminopelargonic acid, ω-aminocapric acid, 1,1-aminoundecanoic acid and 1,2-aminododecanoic acid; lactams such as ε-caprolactam and enanthlactam; a salt of a diamine with a dicarboxylic acid, such as hexamethylene diamine adipate, hexamethylene diamine sebacate, and hexamethylene diamine isophthalate; and a mixture of these polyamide-forming compounds. A beneficial class of polyamide-forming compounds is caprolactam, 1,2-aminododecanoic acid, or a combination of hexamethylene diamine and adipate.

In one embodiment, the antistatic materials are polymeric antistatic agents. The antistatic polymers are generally used in amounts of from 0.015 to 25 wt %. In another embodiment, the antistatic polymers are used in amounts of from 5 to 20 wt %. In yet another embodiment, the antistatic polymers are used in amounts of from 5 to 10 wt % of the total composition. Commercially available antistatic materials include, but are not limited to, Pelestat NC7530 (polyetheresteramide) from Sanyo Chemical) having an RI of about 1.531, IRGASTAT P16, available from CIBA SPECIALTY CHEMICALS, manufactured by Atofina (Pebax MV1074) RI=1.508), Pelestat NC6321 (Sanyo Chemical sold in the Americas by Tomen, RI=1.51); Pelestat 6500, which with the same refractive index as Pelestat NC6321, is a small molecule with salt or electrolyte added to it to increase its conductivity.

The polyesters used in the present invention are any polyester capable of being formed into a miscible mixture with polycarbonate such that the resulting miscible mixture has a refractive index that is capable of being substantially matched with an antistatic material. Examples of polyesters that may be used in the present invention include, but are not limited to, poly(butylene terephthalate) (PBT), poly(ethylene terephthalate) (PET), PET modified with ethylene glycol (PETG), PET modified with polycyclohexamethylene glycol (PCTG), poly(cyclohexane terephthalate) (PCT), polycyclohexanedimethanol cyclohexane dicarboxylate (PCCD), or a combination thereof If the polyester is a glycol-modified polyester, it may be prepared by adding one or more dicarboxylic acid components to one or more glycol components containing 1,|4-cyclohexanedimethanol (CHDM) equaling 100 mole %, the polyester resin having been prepared in the presence of a catalyst/stabilizer system consisting essentially of antimony compounds and phosphorous compounds and compounds selected from the group consisting essentially of zinc compounds, gallium compounds, and silicon compounds.

In one embodiment of the present invention, the polyesters are cycloaliphatic polyesters condensation products of aliphatic diacids, or chemical equivalents and aliphatic diols, or chemical equivalents. The present cycloaliphatic polyesters are, in one embodiment, formed from mixtures of aliphatic diacids and aliphatic diols but should contain at least 50 mole % of cyclic diacid and/or cyclic diol components, the remainder, if any, being linear aliphatic diacids and/or diols. The cyclic components are beneficial since they impart good rigidity to the polyester and permit the formation of transparent blends due to favorable interaction with the polycarbonate resin. On a weight basis, the cycloalphatic poly is, in one embodiment, at least 8 weight % of a cycloalphatic diol and/or a cycloalphiatic dicarbonxylic acid or chemical equivalent thereof with the remainder, if any, being linear aliphatic diol and/or linear aliphatic diacid or equivalents thereof.

In one embodiment, the cycloaliphatic radical in the cycloaliphatic polyester resin is derived from the 1,4-cyclohexyl diacids and, in another embodiment, greater than 70 mole % thereof is in the form of the trans isomer. In one embodiment, the cycloaliphatic radical R is derived from the 1,4-cyclohexyl primary diols such as 1,4-cyclohexyl dimethanol and, in another embodiment, greater than 70 mole % thereof is in the form of the trans isomer.

Other diols useful in the preparation of the cycloaliphatic polyester resins used in the present invention are cycloaliphatic alkane diols. In alternative embodiments, these cycloaliphatic alkane diols contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; 2,2,4,4-tetramethyl-1,3-cyclobutanediol (TMCBD), triethylene glycol; 1,10-decane diol; and mixtures of any of the foregoing. In one embodiment, a cycloaliphatic diol or chemical equivalent thereof and particularly 1,4-cyclohexane dimethanol or its chemical equivalents are used as the diol component.

Chemical equivalents to the diols include esters, such as dialkylesters, diaryl esters and the like, can also be used in the present invention in alternative embodiments.

The diacids useful in the preparation of the aliphatic polyester resins are, in one embodiment, cycloaliphatic diacids. As used herein “diacids” include carboxylic acids having two carboxyl groups each of which is attached to a saturated carbon. In alternative embodiments, the diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or chemical equivalent. Linear dicarboxylic acids like adipic acid, azelaic acid, dicarboxyl dodecanoic acid and succinic acid can be useful in still other embodiments.

Cyclohexane dicarboxylic acids and their chemical equivalents can be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. See, Friefelder et al., Journal of Organic Chemistry, 31, 3438 (1966); U.S. Pat. Nos. 2,675,390 and 4,754,064. In alternative embodiments, they are prepared by the use of an inert liquid medium in which a phthalic acid is at least partially soluble under reaction conditions and with a catalyst of palladium or ruthenium on carbon or silica. See, U.S. Pat. Nos. 2,888,484 and 3,444,237.

Typically, in the hydrogenation, two isomers are obtained in which the carboxylic acid groups are in cis- or trans-positions. The cis- and trans-isomers are separated in one embodiment using crystallization with or without a solvent, for example, n-heptane, or by distillation. The cis-isomer tends to blend better; however, the trans-isomer has higher melting and crystallization temperatures and may be used in select embodiments. Mixtures of the cis- and trans-isomers are useful herein and may be used in alternative embodiments.

When the mixture of isomers or more than one diacid or diol is used, a copolyester or a mixture of two polyesters may be used as the present cycloaliphatic polyester resin.

Chemical equivalents of these diacids include esters, alkyl esters, e.g., dialkyl esters, diaryl esters, anhydrides, salts, acid chlorides, acid bromides, and the like. In one embodiment, the chemical equivalents include the dialkyl esters of the cycloaliphatic diacids, and the most favored chemical equivalent includes the dimethyl ester of the acid, particularly dimethyl-1,4-cyclohexane-dicarboxylate.

In one embodiment, the cycloaliphatic polyester is poly(cyclohexane-1,4-dimethylene cyclohexane-1,4-dicarboxylate) also referred to as poly(1,4-cyclohexane-dimethanol-1,4-dicarboxylate) (PCCD) which has recurring units of formula II:

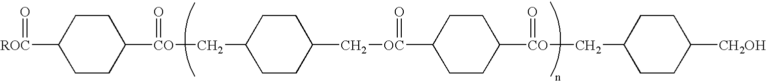

The polyester polymerization reaction is generally run in the melt in the presence of a suitable catalyst such as a tetrakis (2-ethyl hexyl) titanate, in a suitable amount, typically about 50 to 200 ppm of titanium based upon the final product.

In one embodiment, the aliphatic polyesters used in the present transparent molding compositions have a glass transition temperature (Tg) that is above 50° C. In another embodiment, the present transparent molding compositions have a glass transition temperature above 80° C. In still another embodiment, the present transparent molding compositions have a glass transition temperature above 100° C.

Also contemplated herein are the above polyesters with from 1 to 50 percent by weight, of units derived from polymeric aliphatic acids and/or polymeric aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

Polycarbonates useful in the invention include the divalent residue of dihydric phenols, Ar′, bonded through a carbonate linkage and are, in one embodiment, represented by the general formula:

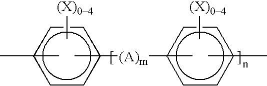

wherein A is a divalent hydrocarbon radical containing from 1 to about 15 carbon atoms or a substituted divalent hydrocarbon radical containing from 1 to about 15 carbon atoms; each X is independently selected from hydrogen, halogen, or a monovalent hydrocarbon radical such as an alkyl group of from 1 to about 8 carbon atoms, an aryl group of from 6 to about 18 carbon atoms, an arylalkyl group of from 7 to about 14 carbon atoms, an alkoxy group of from 1 to about 8 carbon atoms; and m is 0 or 1 and n is an integer of from 0 to about 5. Ar′ may be a single aromatic ring like hydroquinone or resorcinol, or a multiple aromatic ring like biphenol or bisphenol A.

The dihydric phenols employed are known, and the reactive groups are thought to be the phenolic hydroxyl groups. Typical of some of the dihydric phenols employed are bis-phenols such as bis(4-hydroxyphenyl)methane, 2,2-bis(4-hydroxyphenyl)propane (also known as bisphenol-A), 2,2-bis(4-hydroxy-3,5-dibromo-phenyl)propane; dihydric phenol ethers such as bis(4-hydroxyphenyl)ether, bis(3,5-dichloro-4-hydroxyphenyl)ether; p,p′-dihydroxydiphenyl and 3,3′-dichloro-4,4′-dihydroxydiphenyl; dihydroxyaryl sulfones such as bis(4-hydroxyphenyl)sulfone, bis(3,5-dimethyl-4-hydroxyphenyl)sulfone, dihydroxy benzenes such as resorcinol, hydroquinone, halo- and alkyl-substituted dihydroxybenzenes such as 1,4-dihydroxy-2,5-dichlorobenzene, 1,4-dihydroxy-3-methylbenzene; and dihydroxydiphenyl sulfides and sulfoxides such as bis(4-hydroxyphenyl)sulfide, bis(4-hydroxy-phenyl)sulfoxide and bis(3,5-dibromo-4-hydroxyphenyl)sulfoxide. A variety of additional dihydric phenols are available and are disclosed in U.S. Pat. Nos. 2,999,835, 3,028,365 and 3,153,008. It is, of course, possible in alternative embodiments to employ two or more different dihydric phenols or a combination of a dihydric phenol with a glycol.

The carbonate precursors are, in one embodiment, a carbonyl halide, a diarylcarbonate, or a bishaloformate. The carbonyl halides include, for example, carbonyl bromide, carbonyl chloride, and mixtures thereof. The bishaloformates include the bishaloformates of dihydric phenols such as bischloroformates of 2,2-bis(4-hydroxyphenyl)-propane, hydroquinone, and the like, or bishaloformates of glycol, and the like. While all of the above carbonate precursors may be used in alternative embodiments, carbonyl chloride, also known as phosgene, and diphenyl carbonate are preferred.

The aromatic polycarbonates can be manufactured by any processes such as by reacting a dihydric phenol with a carbonate precursor, such as phosgene, a haloformate or carbonate ester in melt or solution. U.S. Pat. No. 4,123,436 describes reaction with phosgene and U.S. Pat. No. 3,153,008 describes a transesterification process.

In one embodiment, polycarbonates are made of dihydric phenols that result in resins having low birefringence for example dihydric phenols having pendant aryl or cup shaped aryl groups like

Phenyl-di(4-hydroxyphenyl) ethane (acetophenone bisphenol):

Diphenyl-di(4-hydroxyphenyl) methane (benzophenone bisphenol):

2,2-bis(3-phenyl-4-hydroxyphenyl) propane

2,2-bis-(3,5-diphenyl-4-hydroxyphenyl) propane;

bis-(2-phenyl-3-methyl-4-hydroxyphenyl) propane;

2,2′-bis(hydroxyphenyl)fluorene;

1,1-bis(5-phenyl-4-hydroxyphenyl)cyclohexane;

3,3′-diphenyl-4,4′-dihydroxy diphenyl ether;

2,2-bis(4-hydroxyphenyl)-4,4-diphenyl butane;

1,1-bis(4-hydroxyphenyl)-2-phenyl ethane;

2,2-bis(3-methyl-4-hydroxyphenyl)-1-phenyl propane;

6,6′-dihdyroxy-3,3,3′,3′-tetramethyl-1,1′-spiro(bis)indane;

Other dihydric phenols that are typically used in the preparation of the polycarbonates are disclosed in U.S. Pat. Nos. 2,999,835, 3,028,365, 3,334,154 and 4,131,575. In alternative embodiments, branched polycarbonates are also useful, such as those described in U.S. Pat. Nos. 3,635,895 and 4,001,184. Polycarbonate blends include blends of linear polycarbonate and branched polycarbonate.

In alternative embodiments, it is also possible to employ two or more different dihydric phenols or a copolymer of a dihydric phenol with an aliphatic dicarboxylic acids like; dimer acids, dodecane dicarboxylic acid, adipic acid, azelaic acid in the event a carbonate copolymer or interpolymer rather than a homopolymer is beneficial for use in the preparation of the polycarbonate mixtures of the invention. Most beneficial are aliphatic C5 to C12 diacid copolymers.

In one embodiment, the polycarbonates are high molecular weight aromatic carbonate polymers have an intrinsic viscosity (as measured in methylene chloride at 25° C.) ranging from about 0.30 to about 1.00 dl/gm. Polycarbonates may be branched or unbranched and generally will have a weight average molecular weight of from about 10,000 to about 100,000, preferably from about 20,000 to about 50,000 as measured by gel permeation chromatography. In another embodiment, it is contemplated that the polycarbonate has various known end groups.

In other alternative embodiments, an impact modifier is employed in the practice of the present invention. If the impact modifier is immiscible with the polycarbonate/polyester miscible mixture, the impact modifier beneficially has an index of refraction that substantially matches the index of refraction of the antistatic polymeric material. In another embodiment, a substantially amorphous impact modifier copolymer resin is added to the present composition in an amount between 1 to 30% by weight and may include one of several different rubbery modifiers such as graft or core shell rubbers or combinations of two or more of these modifiers. Suitable are the groups of modifiers known as acrylic rubbers, ASA rubbers, diene rubbers, organosiloxane rubbers, EPDM rubbers, SBS or SEBS rubbers, ABS rubbers, MBS rubbers and glycidyl ester impact modifiers.

The term “acrylic rubber modifier” as used herein refers, in one embodiment, to multi-stage, core-shell, interpolymer modifiers having a cross-linked or partially crosslinked (meth)acrylate rubbery core phase, preferably butyl acrylate. Associated with this cross-linked acrylic ester core is an outer shell of an acrylic or styrenic resin, preferably methyl methacrylate or styrene, which interpenetrates the rubbery core phase. Incorporation of small amounts of other monomers such as acrylonitrile or (meth)acrylonitrile within the resin shell also provides suitable impact modifiers. The interpenetrating network is provided when the monomers forming the resin phase are polymerized and cross-linked in the presence of the previously polymerized and cross-linked (meth)acrylate rubbery phase.

Beneficial rubbers are graft or core shell structures with a rubbery component with a Tg below 0° C., preferably between about −40° to −80° C., composed of poly alkylacrylates or polyolefins grafted with PMMA or SAN. In one embodiment, the rubber content is at least 40 wt %. In another embodiment, the rubber content is from 60 to 90 wt %.

Typical commercially available rubbers are the butadiene core-shell polymers of the type available from Rohm & Haas, for example Paraloid® EXL2600. In one embodiment, the impact modifier will include a two stage polymer having an butadiene based rubbery core and a second stage polymerized from methylmethacrylate alone or in combination with styrene. In other embodiments, the rubbers are the ABS types Blendex® 336 and 415 available from GE Specialty Chemicals. In one embodiment, the rubber utilized, if immiscible, has a matching index of refraction that substantially matches the index of refraction of the antistatic polymeric material, or, if miscible with the polycarbonate/cycloaliphatic polyester blend, is used in the appropriate proportion so that the resulting mixture has an index of refraction substantially matching the index of refraction of the polymeric antistatic material.

The impact modifier, if employed, should, in one embodiment, have an index of refraction (RI) essentially the same as the RI of the antistatic polymer. It should also be compatible with the other ingredients.

In one embodiment, the polycarbonate, polyester compositions of the present invention include A) from 20 to 80% by weight of a blend of polycarbonate and polyester resin, providing that the ratio of polyester resin to polycarbonate resin is from 1.0 to 2 and, in an alternative embodiment, from 1.6 to 1.9, wherein the polyester is a cycloaliphatic polyester resin that includes the reaction product of (a) at least one cycloaliphatic C₂-C₁₂ alkane diol, such as a C₆-C₁₂ cycloaliphatic diol, or chemical equivalent thereof, and (b) at least one cycloaliphatic diacid, such as a C₆-C₁₂ diacid, or chemical equivalent thereof, (B) from 0.01 to 25 weight % of a static dissipating polymer. In an alternative embodiment, the polycarbonate, polyester compositions include the static dissipating polymer in an amount from 5 to 20 weight % and, in yet another embodiment, from 5 to 10 weight %. In other embodiments, the compositions include (C) from 1 to 30%, and in an alternative embodiment from 5 to 20% by weight, of an impact modifier.

The method of blending the compositions may be carried out by conventional techniques. In one embodiment, the polyester and polycarbonate are pre-blended in an amount selected to substantially match the refractive index of the static dissipating polymer. The ingredients are, in one embodiment, in powder or granular form, extruding the blend and comminuting into pellets or other suitable shapes for molding. The ingredients are, in one embodiment, combined in any usual manner, such as by dry mixing or by mixing in the melted state in an extruder, or in other blending processes.

In the thermoplastic compositions that contain a polyester resin and a polycarbonate resin it is possible, in one embodiment, to use a stabilizer or quencher material. Catalyst quenchers are agents that inhibit activity of any catalysts that may be present in the resins. Catalyst quenchers are described in detail in U.S. Pat. No. 5,441,997. It may be beneficial, in one embodiment, to select the correct quencher to avoid color formation and loss of clarity to the composition herein described.

Beneficial classes of stabilizers including quenchers are those that provide a transparent and colorless product. Typically, such stabilizers are used at a level of 0.001 to about 10 weight percent and, in alternative embodiments, at a level of from 0.005 to about 2 weight percent. In one embodiment, the stabilizers include an effective amount of an acidic phosphate salt; an acid, alkyl, aryl or mixed phosphite having at least one acidic hydrogen; a Group IB or Group IIB metal phosphate salt; a phosphorus oxo acid, a metal acid pyrophosphate or a mixture thereof. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. The acidic phosphate salts include sodium dihydrogen phosphate, mono zinc phosphate, potassium hydrogen phosphate, calcium dihydrogen phosphate and the like.

The phosphate salts of a Group IB or Group IIB metal include zinc phosphate and the like. The phosphorus oxo acids include phosphorous acid, phosphoric acid, polyphosphoric acid or hypophosphorous acid.

The most beneficial quenchers are oxo acids of phosphorus or acidic organo phosphorus compounds. Inorganic acidic phosphorus compounds may also be used as quenchers, however they may result in haze or loss of clarity. Most beneficial quenchers are phosphoric acid, phosphorous acid or their partial esters.

The compositions of the present invention provide antistatic properties that substantially carry through to articles or applications that are made and include at least on embodiment of a composition of the present invention. Accordingly, the compositions of the present invention find use in a great number of applications wherein it is beneficial for the application or article of manufacture to have anti-static properties.

The compositions of the present invention, due to the substantial matching of the refractive indexes of the various components, are also substantially clear. Accordingly, the compositions of the present invention find use in a great number of applications wherein it is beneficial for the application or article of manufacture to be substantially transparent. As used herein, the term “substantially transparent” refers, in one embodiment, to a composition or article wherein at least 80% of visible light passes there through. In an alternative embodiment, the term “substantially transparent” refers to a composition or article wherein at least 90% of visible light passes there through.

Accordingly, in another aspect of the present invention, the present invention includes articles of manufacture that are formed and include one or more anti-static and/or substantially transparent compositions according to one or more embodiments of the present invention. The articles may include any article in which anti-static characteristics and/or substantial transparency would be beneficial or desired. Examples of applications in which the compositions may be used include, but are not limited to, semiconductor design and processing applications such as silicone wafer handling and processing, shipping and storage boxes, photomask cassettes, carrier tape, and passive and active electronic component handling and processing trays; data storage device handling applications such as hard disk drive component processing trays, card guides and card cages; electronics handling/processing applications such as grounding straps, grounding pads, air ionizers/de-ionizers, soldering and desoldering equipment, flat panel display handling, and processing and shipping cassettes; and healthcare applications such as component processing trays, nebulizers, and respirators.

### EXAMPLES

The following examples serve to illustrate the invention but are not intended to limit the scope of the invention. Blends were prepared by dry blending the appropriate quantities in a Henschel high-speed mixer. The dry blends were extruded in a 30 mm Werner and Pfleiderer Twin Screw extruder. A strand of static dissipating polymer and a polycarbonate composition containing PCCD as set forth in the Tables. The antistatic dissipating polymer employed in the Example was a polyetheresteramide (Pelestat NC7530 from Sanyo Chemical) having an RI of about 1.531. A standard stabilizing amount of 0.07 and 0.1 respectively, of monozinc phosphate and phosphorous acid ester was added to the blends of this example. A strand of clear antistatic containing thermoplastic resin composition emerging from the extruder was cooled in a water bath, pelletized, dried and injection molded on an 85 ton Van Dorn molding machine to obtain test samples.

Samples were tested for flexural strength and flexural modulus as per ASTM D790, tensile strength and elongation as per ASTM D638, notched izod as per ASTM D256. Heat distortion temperature (HDT) was performed on 0.5″×0.125″×5″ bar at 264 pounds per square inch (psi) load at 248° F. 1 hour finishing at 554° F. as per ASTM D648. Haze was measured via a Color-Edge 7000 Series instrument. The refractive index (RI) of the blends in the following examples were calculated to be ˜1.535 (PC ˜1.58, PCCD ˜1.506 and Pelestat NC7530 again having an RI˜1.531). The ratio of PCCD/PC in Table 1 was 1.8 to 1. The results are as follows:

TABLE 1
Examples

| | Anti Static | Haze/ | Notched Izod/ft | FM × 10³/ | |
|---|---|---|---|---|---|
| Experiment | Resin/% | % | lb/″ of notch | psi | HDT/° F. |
| 1 | 5 | 6.25 | 21.6 | 244.4 | 160 |
| 2 | 10 | 6.58 | 14.1 | 225.8 | 158 |
| 3 | 15 | 7.87 | 19.1 | 204.4 | 153 |

The blends produced transparent and colorless parts.

The following Table 2 shows properties of blends when the PCCD/PC ratio is the range as shown in the Table 2 below

TABLE 2
Comparative Examples

| | | | | | | Notched | | |
|---|---|---|---|---|---|---|---|---|
| | | | | % | | Izod ft | | |
| | % | | Ratio | Antistatic | | lb/″ of | | |
| Experiment | PCCD | % PC | PCCD/PC | resin | % Haze | notch | FM × 10 | HTD ° F. |
| C4 | 75 | 15 | 5 | 0 | 5.1 | 21.2 | 210.0 | 139 |
| C5 | 75 | 15 | 5 | 10 | 78 | 17.9 | 188.9 | 139 |
| C6 | 65 | 13 | | | | | | |
| C7 | 67 | 13 | 5 | 20 | 97 | 16 | | 134 |
| C8 | 14 | 71 | 5 | 15 | 92 | 21.9 | 169.8 | 136 |
| C9 | 65 | 25 | 2.6 | 10 | 45 | 21.0 | 203.6 | 143 |

As shown from the above Table 2, without the antistatic dissipating polymeric resin, Experiment C4 the % haze is quite low (5.1%). However, the composition does not have static electricity dissipating properties. Also note that, even with a ratio of 2.6 PCCD/PC, the haze % is extremely high compared to PCCD/PC blend ratio in the 1.8 to 1.0 ratio. Preferable the PCCD/PC ratio is less than about 2, more preferable from about 2 to about 1.6, and more preferable from about 1.9 to about 1.7. Also the heat distortion, HDT, is significantly lower than the compositions of the invention, Experiment 1-3 of Table 1. The above selected ratios are also beneficial for reduced heat distortion.

While the invention has been described with reference to a preferred embodiment, it will be understood by those skilled in the art that various changes may be made and equivalents may be substituted for elements thereof without departing from the scope of the inventor. In addition, many modifications may be made to adapt a particular situation or material to the teachings of this invention without departing from the scope hereof. Therefore, it is extended that the invention not be limited to the particular embodiment disclosed as the best mode contemplated for carrying out this invention, but that this invention will include all embodiments falling within the scope of the appended claims.

What is claimed:

1. An substantially transparent article of manufacture comprising:
a permanent electrostatic dissipating composition comprising a miscible mixture of an aromatic polycarbonate resin and a polyester resin, and an amount of an electrostatic dissipating polymer sufficient to impart electrostatic dissipative properties to the article;
wherein the aromatic polycarbonate, the polyester, and the electrostatic dissipating polymer, each have a predetermined index of refraction,
wherein the electrostatic dissipating polymer has a refractive index value between the refractive index value of the polycarbonate resin and the refractive index value of the polyester resin,
wherein the miscible mixture of the polycarbonate resin and the polyester resin are present in the electrostatic dissipating composition for substantially matching the index of refraction of the electrostatic dissipating polymer, and
wherein the refractive index of the miscible mixture is within 0.015 units of the refractive index of the electrostatic dissipating polymer.

2. The article of claim 1, wherein the polyester resin is selected from poly(butylene terephthalate) (PBT), poly(ethylene terephthalate) (PET), PET modified with ethylene glycol (PETG), PET modified with polycyclohexamethylene glycol (PCTG), poly(cyclohexane terephthalate) (PCT), polycyclohexanedimethanol cyclohexane dicarboxylate (PCCD), or a combination thereof

3. The article of claim 1, wherein the polyester resin is a cycloaliphatic copolyester, and
wherein the cycloaliphatic copolyester comprises the reaction product selected from the group consisting of (1) at least 80 weight % of cycloaliphatic diol with the remainder, if any, being a linear aliphatic diol, or a combination of a linear aliphatic diol and a linear aliphatic diacid, or chemical equivalents of the above, (2) at least 80 weight % of a cycloaliphatic dicarboxylic acid with the remainder, if any, being a linear aliphatic diacid, or a combination of a linear aliphatic diacid and a linear aliphatic diol or chemical equivalents of above, and (3) a mixture of at least 80 weight % of a cycloaliphatic diol and at least 80 weight % of a cycloaliphatic dicarboxylic acid with the remainder, if any, being a linear aliphatic diol or a linear aliphatic diacid or a mixture of the two, or chemical equivalents of the above.

4. The article of claim 1, wherein the refractive index of the miscible mixture is within 0.005 units of the refractive index of the electrostatic dissipating polymer.

5. The article of claim 1, wherein the ratio of polyester to polycarbonate is from 2.0 to 1.6 and combined weight of polycarbonate and polyester is 20 to 80% by weight of the total weight of the composition.

6. The article of claim 1, wherein the electrostatic dissipating polymer is present in an amount of from 0.01 to 25 weight % of the total weight of the composition.

7. The article of claim 3 wherein the electrostatic dissipating polymer is present in an amount of 5 to 15 weight %

8. The article of claim 1 wherein the polyester is poly (1,4-cyclohexane-dimethanol-1,4-dicaroxylate).

9. The article of claim 1 wherein the electrostatic dissipating polymer is selected from copolyesteramides, polyether-polyamides, polyetheramide block copolymers, polyetherester-amide block copolymers, polyurethane containing a polyalkyalkylene glycol moeity, polyetheresters, or mixtures thereof.

10. The article of claim 9 wherein the electrostatic dissipating polymer is a polyesteramide.

11. The article of claim 9, wherein the electrostatic dissipating polymer is polyetheresteramide.

12. The article of claim 1, further comprising an impact modifier,
wherein the impact modifier has a refractive index similar to the refractive index of the permanent electrostatic dissipating composition.

13. The article of claim 12, wherein the impact modifier is a rubbery modifier.

14. The article of claim 13, wherein the impact modifier is a core-shell modifier having at least a partially cross-linked (meth) acrylate rubber core phase and an outer shall comprising an acrylic resin.

15. The article of claim 1, wherein the refractive index of the permanent electrostatic dissipating composition is 1.52 to 1.54.

16. The article of claim 1, wherein the article is selected from silicone wafer handling articles, silicone wafer processing articles, shipping boxes, storage boxes, photo mask cassettes, carrier tape, electronic component handling and processing trays, hard disk drive component processing trays, card guides, card cages, grounding straps, grounding pads, air ionizers/de-ionizers, soldering and desoldering equipment, flat panel display handling, processing and shipping cassettes, component processing trays, and respiratory care and treatment devices such as nebulizers, or respirators.
